(19) United States
(12) Patent Application Publication
(10) Pub. No.: US 2008/0013594 A1
(43) Pub. Date: Jan. 17, 2008

(54) Nondestructive Inspection Method For Inspecting Junction Of Flexible Printed Circuit Board

(75) Inventor: Kohichiro Kawate, Tokyo (JP)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/814,930

(22) PCT Filed: Feb. 2, 2006
(86) PCT No.: PCT/US06/03608

§ 371 Date: Jul. 27, 2007

(30) Foreign Application Priority Data
Feb. 25, 2005 (JP) 2005-050808

(51) Int. Cl. G01N 25/00

(52) U.S. Cl. 374/45

(57) ABSTRACT

It is an object of the present invention to provide a nondestructive inspection method which does not use X-ray or gamma radiation that may exert adverse effect on human body and which is capable of easily and reliably detecting inconvenient defects in junction. An apparatus comprises a stage capable of supporting the test specimen, a strobe light source for heating the surface of the junction of the test specimen, and an infrared thermograph capable of measuring temporal variation of the surface temperature of the junction of the test specimen. Preferably, the stage has a heat sink to which the test specimen can be mounted for promoting temperature variation, that is, cooling, of the heated test specimen.

### TECHNICAL FIELD

The present invention relates to a nondestructive inspection method for determining whether a junction of a flexible printed circuit board is electrically connected or not.

### BACKGROUND ART

Conventional nondestructive inspection method for inspecting a junction consists in, for example, examining the shape of the junction using X-ray or gamma radiation. For example, Patent Document 1 (Japanese Unexamined Patent Publication (Kokai) No. 2004-251917) discloses a nondestructive inspection method using X-ray used for nondestructive inspection of internal structure of a sample.

### BRIEF DESCRIPTION OF THE DRAWINGS

FIG. 1(a) is a schematic view showing FPC of a test specimen inspected by the nondestructive inspection method according to the present invention;

FIG. 1(b) is a partially enlarged view showing the conductor on FPC of FIG. 1(a);

FIG. 2 is a view showing the conductor of FIG. 1(b) which has been subjected to embossing;

FIG. 3 is a view showing the conductor of FIG. 2 with an adhesive laminated thereon;

FIG. 4(a) is a schematic view showing PCB to be conductively connected to FPC of FIG. 1(a);

FIG. 4(b) is a partially enlarged view of FIG. 4(a);

FIG. 5 is a view showing the joining of FPC and PCB;

FIG. 6 is a schematic view showing FPC and PCB conductively connected to each other;

FIG. 7 is a schematic view showing the construction of the apparatus for carrying out the nondestructive inspection method according to the present invention;

FIG. 8 is a schematic sectional view showing the conductively connected junction of the test specimen; and

FIG. 9 is a view showing an example of measurement result of the test specimen using thermograph.

### DISCLOSURE OF INVENTION

### Problems to be Solved by the Invention

With such a method using X-ray or gamma radiation, it is possible that existence of a minute gap (for example, a gap of 1 μm or smaller) between junctions may fail to be detected. In addition, X-ray or gamma radiation may exert adverse effect upon human health, and therefore, handling of such an apparatus requires great care.

Therefore, an object of the present invention is to provide a nondestructive inspection method which does not use X-ray or gamma radiation that may exert adverse effect on human body and which is capable of easily and reliably detecting inconvenient defects in junction.

### Means for Solving the Problems

In order to attain above object, in accordance with the invention as claimed in claim 1, there is provided a nondestructive inspection method comprising the steps of: providing a flexible printed circuit board and a base member electrically conductively connected to each other; heating a junction of the flexible printed circuit board and the base member such that a generally uniform temperature is achieved over the entire surface of the junction; measuring temporal variation of the surface temperature of the junction after heating of the junction; and inspecting the electrically conductive state of the junction based on the measurement result of the temporal variation of the surface temperature of the junction.

In accordance with the invention as claimed in claim 2, there is provided a nondestructive inspection method according to claim 1, wherein the flexible printed circuit board and the base member are partially conductively connected to each other at the junction, and wherein the step of inspecting includes determining, based on the surface temperature at partially conductively connected portions in the junction dropping more rapidly than the surface temperature at portions other than the partially conductively connected portions, that electrically conductive connection is made at the partially conductively connected portions.

In accordance with the invention as claimed in claim 3, there is provided a nondestructive inspection method according to claim 1 or 2, wherein the step of heating includes heating the junction with irradiated light from a light source disposed outside of the junction.

In accordance with the invention as claimed in claim 4, there is provided a nondestructive inspection method according to claim 3, wherein the light source has an annular shape.

In accordance with the invention as claimed in claim 5, there is provided a nondestructive inspection method according to any one of claims 1 to 4, wherein an infrared thermograph is used in the step of measuring.

### Effect of the Invention

With the nondestructive inspection method according to the present invention, the state of conductive connection of junction can be easily and reliably inspected without using X-ray or gamma radiation which may exert adverse effect upon human body.

### Best Mode for Carrying out the Invention

Next, the present invention will be described in detail with reference to the drawings.

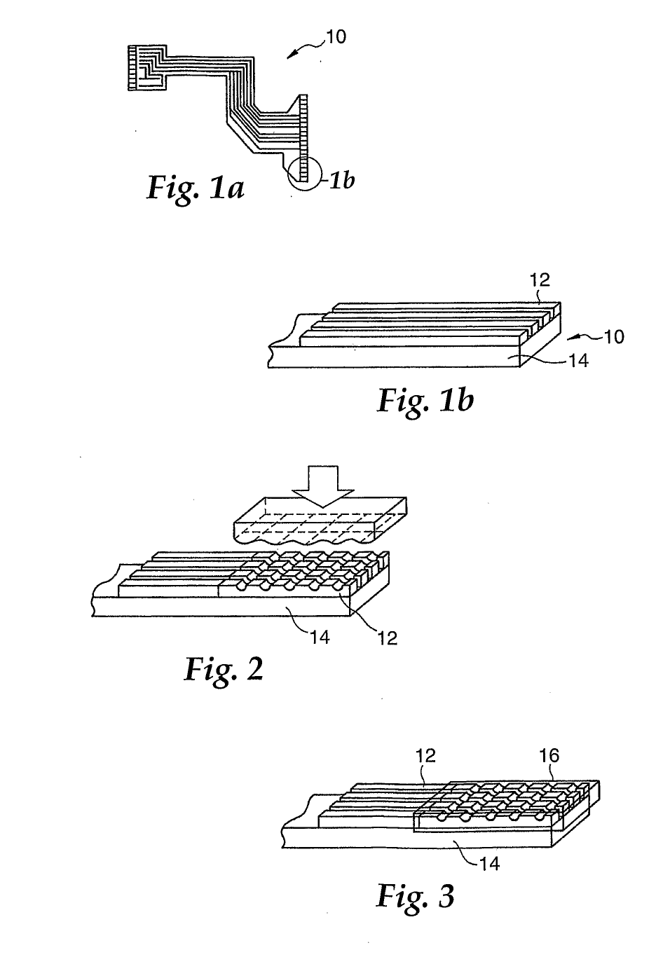

FIGS. 1 to 5 are views showing the preparation method for preparing a test specimen suitable for application of the nondestructive inspection method according to the present invention. This preparation method uses electrically insulating film to connect flexible printed circuit boards.

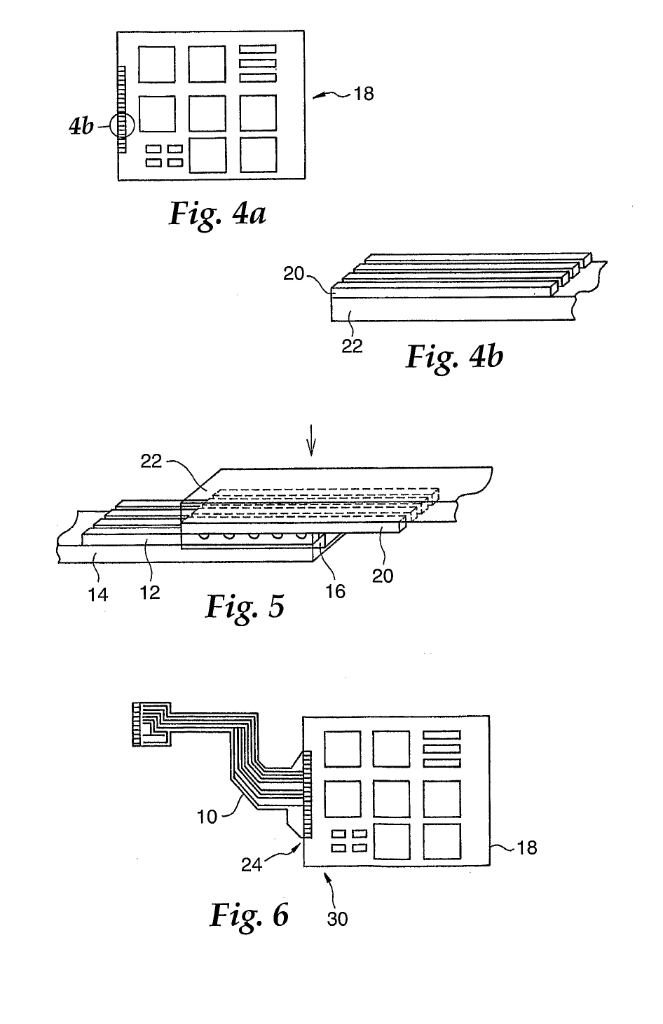

First, as shown in FIG. 1(a) and (b), a flexible printed circuit board 10 (hereinafter referred to simply as FPC) having an electrical conductor 12 formed on a base plate 14 made of polyimide or the like, is provided. Next, as shown in FIG. 2, a portion of the conductor 12 of FPC 10 is embossed to form ruggedness on the surface of the conductor 12. Then, as shown in FIG. 3, an adhesive 16, based on, for example, epoxy resin, is laminated on the embossed portion of the conductor 12. Then, a base member or a printed circuit board 18 (hereinafter referred to simply as PCB) having an electrical conductor 20 to be conductively connected to the electrical conductor 12 of FPC 10 formed on a rigid substrate 22 of glass epoxy material or the like, is provided as shown in FIG. 4(a). Finally, as shown in FIG. 4(b), the conductor 20 of PBC 18 is adhered to the conductor 12 of FPC 10 by hot pressing or the like. During this hot pressing, the adhesive between the convex portion of the conductor 12 and the conductor 20 is squeezed out to the surrounding of the convex portion, so that the conductor 12 and the conductor 20 come into direct contact with each other so as to be conductively connected. The test specimen 30 provided with junction 24 as shown in FIG. 6 is thus prepared.

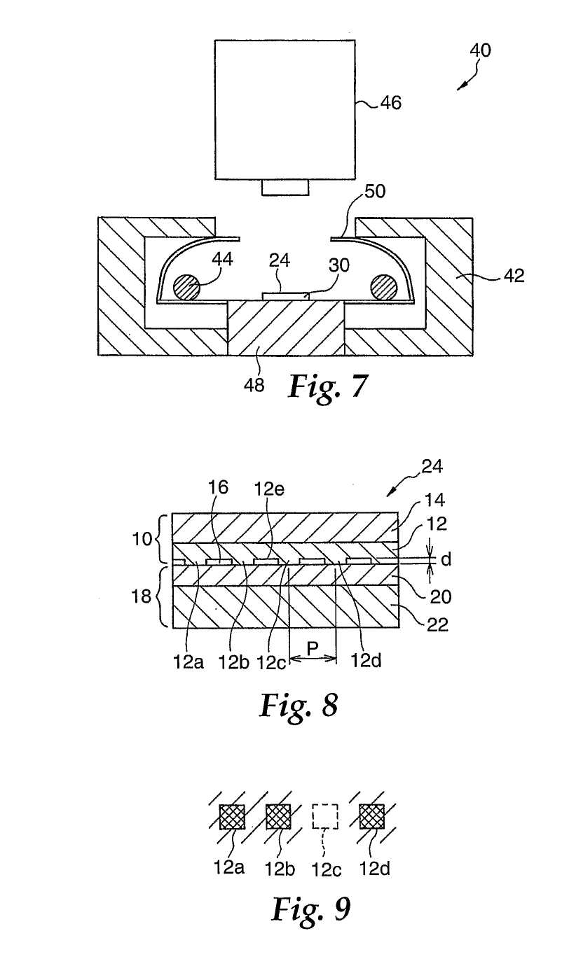

Next, FIG. 7 is a view showing schematically an apparatus 40 for carrying out a preferred nondestructive inspection method according to the present invention. The apparatus 40 comprises a stage 42 capable of supporting the test specimen 30 as described above, a strobe light source 44 such as a xenon lamp for heating the surface of the junction 24 of the test specimen 30, and an infrared thermograph 46 capable of measuring temporal variation (for example, at an interval of 0.1 second) of the surface temperature of the junction 24 of the test specimen 30. Known infrared thermograph utilizing infrared radiation may be used as the thermograph 46. Preferably, the stage 42 has a heat sink 48 to which the test specimen can be mounted for promoting temperature variation, that is, cooling, of the heated test specimen 30. Preferably, the position of the heat sink 48 may be adjusted in any direction, that is, in any of X-, Y-, and Z-directions.

The apparatus 40 is constructed such that the surface of the junction 24 can be heated uniformly so as to achieve uniform surface temperature over the entire surface of the junction 24 of the test specimen 30. For this purpose, the strobe light source 44 has a shape, for example annular shape, that can uniformly irradiate light on the junction 24 from outside. Even with such a shape, there is still difference in the distance from the light source between the central portion and the peripheral portion of the junction 24. Therefore, in order to compensate for the temperature difference that may arise from this difference in distance from the light source, the apparatus 40 is preferably further provided with a reflection mirror 50 for reflecting irradiated light from the strobe light source 44 that does not directly impinge upon the surface of the junction 24 back to the surface of the junction 24.

In place of the thermograph 46, an infrared camera which utilizes infrared light in the same way as an infrared thermograph may be used. In this case, also, temperature distribution of the entire junction can be viewed using an image display.

In place of an infrared thermograph or an infrared camera which provides an image display of temperature distribution of the junction 24 of the test specimen 30, a spectroscopic radiation meter or a spot radiation thermometer that allows spot measurement of the portion to be measured (that is, conductively connected portions and other portions) may be used. In this case, instead of visually displaying temperature distribution over the whole junction 24, temperature of each portion is numerically indicated. By measuring temperature variation of the portions for which the state of conductive connection is to be checked and other portions at suitable time interval (for example, at an interval of 0.1 second), data on temporal variation of temperature required in the nondestructive inspection method of the present invention may be obtained.

In the method of the present invention, the thermograph 46 generally measures the surface temperature of the back surface of the base plate 14 of FPC 10 (that is, the surface not connected to PCB 18). Therefore, in order to apply the above-described nondestructive inspection method according to the present invention, it is desired that the thickness of the base plate 14 be not greater than a specified thickness. As an example, in the section of the junction 24 shown in FIG. 8, the base plate 14 of FPC 10 is preferably not greater than 100 μm in thickness, and is more preferably a polyimide film of 12.5, 25, 50 and 75 μm in thickness. The conductor 12 of FPC 10 is preferably not greater than 50 μm in thickness, and is more preferably a copper foil of 4, 9, 12, 18 and 35 μm in thickness.

On the other hand, like the conductor 12 of FPC 10, the conductor 20 of PCB 18 is preferably not greater than 50 μm in thickness, and is more preferably a copper foil of 4, 9, 12, 18 and 35 μm in thickness. The rigid substrate 22 of PCB 18 is preferably a glass epoxy plate of about 100-500 μm in thickness, but it may be a flexible substrate of polyimide as in the case of the base plate 14 of FPC 10.

Height d of the convex portion 12a-12d of the conductor 12 of FPC 10 (that is, the distance in the thickness direction between the concave portion 12e and the conductor 20) is preferably about 3-10 μm, and more preferably about 5 μm. Pitch p between the neighboring convex portions is preferably about 0.1-0.3 μm, and more preferably about 0.2 μm. With respect to the pitch p, resolution of the thermograph 46 is required to be smaller than the pitch p.

Next, procedure of the nondestructive inspection method of the present invention will be described below.

A test specimen 30 consisting of FPC 10 and PCB 18 electrically conductively connected to each other is provided as described before, and is placed on the heat sink 48 (see FIG. 7). Then, the junction 24 is heated by irradiation of light generated from the strobe light source 44 so as to obtain generally uniform temperature over the entire surface of the junction 24 of the test specimen 30. Immediately after light generation (that is, after the surface temperature of the junction 24 is raised to a uniform temperature), temporal variation of the surface temperature of the junction 24 is measured using the thermograph 46. Since the surface temperature generally drops relatively rapidly, measurement of temporal variation of the surface temperature is preferably performed immediately after the generation of strobe light at an interval of 0.1-0.3 second for several seconds.

An example of measurement result obtained by the above-described method using the thermograph 46 is shown in FIG. 9. FIG. 9 is a schematic view showing a part of output image of the junction 24 obtained by the thermograph, and shows the surface temperature distribution at some time-point after light generation of the strobe light source. Since, as shown in FIG. 8, the conductor 12 of FPC 10 has ruggedness at the junction 24, only the convex portion of the conductor 12 is actually conductively connected at the junction 24. The nondestructive inspection method of the invention makes use of the fact that thermal conductivity from FPC 10 to PCB 18 differs greatly between the portions actually conductively connected (in the example of FIG. 8, convex portions 12a-12d) and other portions not conductively connected. Thus, thermal conductivity at the portion where metals are directly in contact with each other, that is, at the convex portions, is several tens to several hundreds times greater than the thermal conductivity at the portions where resin adhesive is generally interposed (in some cases, simple gap with no adhesive interposed), that is, at concave portions. Therefore, after heating with light generation from the strobe light source, the convex portions and their surroundings cool down (that is, transfer heat from FPC 10 to PCB 18) more rapidly than the concave portions and their surroundings. In the example shown in FIG. 9, for example, among the plurality of convex portions, only the convex portion 12c has higher temperature at some time point (that is, has slower cooling rate) than others. This indicates that reliable conductive connection has not been made for some reasons. In this way, by measuring temporal variation of surface temperature of the junction, state of electrical connection of each conductively connected portion, that is, each convex portion, can be inspected nondestructively. Even a microscopic gap of about 1 μm between conductively connected portions, which may be overlooked in nondestructive inspection method using X-ray or gamma radiation, lowers the thermal conductance at the relevant portion, so that nondestructive inspection method according to the invention does not overlook such a microscopic gap.

In the method of the invention, the base plate of FPC is heated by irradiation with light so as to raise its temperature uniformly in a short time period, and subsequent cooling, that is, heat transfer, is monitored to detect a gap in the junction. Therefore, any material may be joined to FPC. Specifically, junction between FPC and FPC, a hard printed circuit board, a glass substrate or a semiconductor chip, may be inspected by the nondestructive inspection method of the invention. Although the method of the invention is particularly suitable for nondestructive inspection of a junction partially conductively connected, it is to be understood that the method of the present invention may be applied to junctions formed by other method as well, and that the state of conductive connection of junctions can be easily and reliably inspected in any case.

1. A nondestructive inspection method comprising the steps of:
providing a flexible printed circuit board and a base member electrically conductively connected to each other;
heating a junction of the flexible printed circuit board and the base member such that a generally uniform temperatures is achieved over the entire surface of the junction;
measuring temporal variation of the surface temperature of the junction after heating of the junction; and
inspecting the electrically conductive state of the junction based on the measurement result of the temporal variation of the surface temperature of the junction.

2. The nondestructive inspection method as set forth in claim 1, wherein the flexible printed circuit board and the base member are partially conductively connected to each other at the junction, and wherein the step of inspecting includes determining, based on the surface temperature at partially conductively connected portions in the junction dropping more rapidly than the surface temperature at portions other than the partially conductively connected portions, that electrically conductive connection is made at the partially conductively connected portions.

3. The nondestructive inspection method as set forth in claim 1, wherein the step of heating includes heating the junction with irradiated light from a light source disposed outside of the junction.

4. The nondestructive inspection method as set forth in claim 3, wherein the light source has an annular shape.

5. The nondestructive inspection method as set forth in claim 1, wherein an infrared thermograph is used in the step of measuring.
